(19) United States
(12) Patent Application Publication
(10) Pub. No.: US 2023/0419742 A1
(43) Pub. Date: Dec. 28, 2023

(54) TASK MANAGEMENT DEVICE, SYSTEM, VEHICLE, AND TASK MANAGEMENT METHOD

(71) Applicant: TOYOTA JIDOSHA KABUSHIKI KAISHA, Toyota-shi Aichi-ken (JP)

(72) Inventors: Hirotaka Nogami, Nisshin-shi Aichi-ken (JP); Jun Tsukamoto, Seto-shi Aichi-ken (JP); Tsuyoshi Okada, Nagoya-shi Aichi-ken (JP); Fumiyuki Kagara, Sagamihara-shi Kanagawa-ken (JP); Kotaro Hirose, Nisshin-shi Aichi-ken (JP); Yoshiki Terashima, Okazaki-shi Aichi-ken (JP); Yohei Ando, Okazaki-shi Aichi-ken (JP)

(73) Assignee: TOYOTA JIDOSHA KABUSHIKI KAISHA, Toyota-shi Aichi-ken (JP)

(21) Appl. No.: 18/135,879

(22) Filed: Apr. 18, 2023

(30) Foreign Application Priority Data
Jun. 23, 2022 (JP) 2022-101402

(51) Int. Cl. G07C 5/00; B60S 1/00

(52) U.S. Cl. CPC G07C 5/006; G07C 5/008; B60S 1/00

(57) ABSTRACT

A task management device includes a control unit that detects a deterioration of an internal environment of a vehicle as an environmental deterioration during a period in which the vehicle to be operated in a mode in accordance with an application is operated in a first mode, calculates a time required for maintenance of the internal environment of the vehicle in accordance with the detected environmental deterioration and determines whether the maintenance is completed by a mode switching time limit for switching the mode of the vehicle to a second mode that is different from the first mode, and executes operational control in accordance with a determination result obtained.

### CROSS-REFERENCE TO RELATED APPLICATION

This application claims priority to Japanese Patent Application No. 2022-101402 filed on Jun. 23, 2022, incorporated herein by reference in its entirety.

### BACKGROUND

### 1. Technical Field

The present disclosure relates to a task management device, a system, a vehicle, and a task management method.

### 2. Description of Related Art

Japanese Unexamined Patent Application Publication No. 2020-170456 (JP 2020-170456 A) discloses a system for managing vehicles that can be used for multiple purposes.

### SUMMARY

When the use of a vehicle is changed, such as a change from a mobile store vehicle or a delivery vehicle to a bus, it is conceivable that it takes time to perform maintenance for the internal environment of the vehicle, such as cleaning the inside of the vehicle, and the switching of the use of the vehicle is delayed.

An object of the present disclosure is to enable a flexible operation in accordance with the time required for maintenance of the internal environment of the vehicle.

A task management device according to the present disclosure includes a control unit that detects a deterioration of an internal environment of a vehicle as an environmental deterioration during a period in which the vehicle to be operated in a mode in accordance with an application is operated in a first mode, calculates a time required for maintenance of the internal environment of the vehicle in accordance with the detected environmental deterioration and determines whether the maintenance is completed by a mode switching time limit for switching the mode of the vehicle to a second mode that is different from the first mode, and executes operational control in accordance with a determination result obtained.

A task management method according to the present disclosure includes: detecting, by a control unit, deterioration of an internal environment of a vehicle as an environmental deterioration during a period in which the vehicle to be operated in a mode in accordance with an application is operated in a first mode; by the control unit, calculating a time required for maintenance of the internal environment of the vehicle in accordance with the detected environmental deterioration and determining whether the maintenance is completed by a mode switching time limit for switching the mode of the vehicle to a second mode that is different from the first mode; and executing, by the control unit, operational control in accordance with a determination result obtained.

According to the present disclosure, it is possible to perform a flexible operation in accordance with the time required for the maintenance of the internal environment of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a block diagram showing a configuration of a task management device according to the embodiment of the present disclosure;

FIG. 3 is a flowchart showing an operation of the task management device according to the embodiment of the present disclosure;

FIG. 4 is a flowchart showing a modification of the operation of the task management device according to the embodiment of the present disclosure;

FIG. 5 is a flowchart showing another modification of the operation of the task management device according to the embodiment of the present disclosure; and

FIG. 6 is a flowchart showing still another modification of the operation of the task management device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

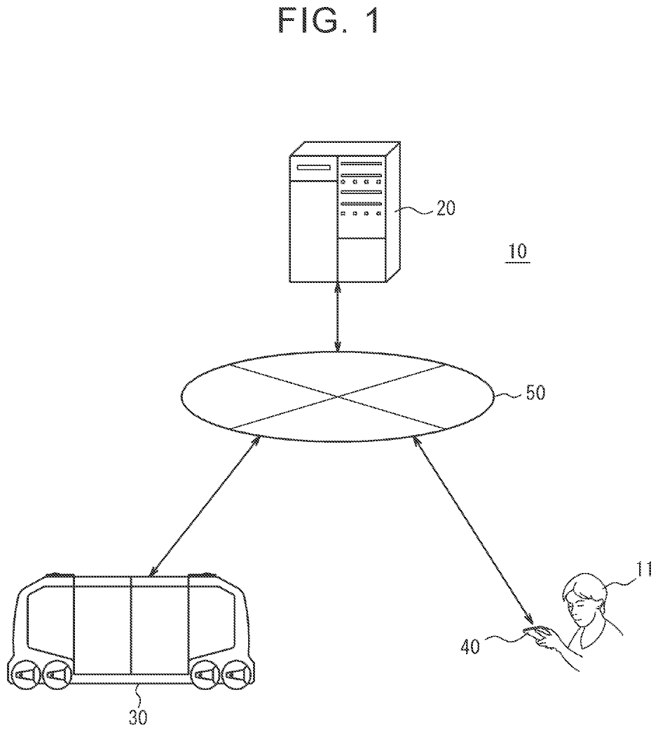

The configuration of a system 10 according to the present embodiment will be described with reference to FIG. 1.

The system 10 according to the present embodiment includes at least one task management device 20, at least one vehicle 30, and at least one terminal device 40. The task management device 20 can communicate with the vehicle 30 and the terminal device 40 via a network 50.

The task management device 20 is installed in a facility such as a data center and operated by a business operator that manages the vehicle 30. The task management device 20 is a computer such as a server belonging to a cloud computing system or other computing system.

The vehicle 30 is operated in a mode in accordance with its application, such as delivery of articles, transportation of passengers, or sale of products. The mode of the vehicle 30 is switched by changing the interior, the exterior, or both. The vehicle 30 is, for example, a mounted vehicle in which rear seats can be freely removed or moved or a table can be freely installed without using tools, by using a dedicated floor structure that utilizes a plurality of rails. For example, the vehicle 30 is equipped with a display such as an LCD or an organic EL as part of the exterior, and can freely change the exterior by switching the contents displayed on the display. The term “LCD” is an abbreviation for “liquid crystal display”. The term “EL” is an abbreviation for “electroluminescent”. The vehicle 30 may be utilized as an on-demand bus, may be equipped with a power source, lighting, a table, a monitor, or any combination thereof and used as a business meeting space or an office at the destination, or may also be used for other purposes such as sale of products, delivery of articles, or provision of administrative services. Changing the interior, the exterior, or both of the vehicle 30 makes it possible to use the vehicle 30 differently depending on the day of the week or the time period.

The vehicle 30 is a vehicle of any type, such as a gasoline vehicle, a diesel vehicle, a hydrogen vehicle, an HEV, a PHEV, a BEV, or an FCEV. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 30 is an AV according to the present embodiment. However, the vehicle 30 may be driven by the driver, or the driving may be automated at any level. The term “AV” is an abbreviation for autonomous vehicle. The level of autonomous driving is, for example, one of levels 1 to 5 in the SAE leveling, for example. The term “SAE” is an abbreviation for the “Society of Automotive Engineers”. The vehicle 30 may be a MaaS dedicated vehicle. The term “MaaS” is an abbreviation for “mobility as a service”.

The terminal device 40 is held by a user 11 or installed at an arbitrary location such as the house of the user 11 and used by the user 11. The terminal device 40 is, for example, a mobile device such as a mobile phone, a smartphone, or a tablet, or a PC. The term “PC” is an abbreviation for “personal computer”.

The network 50 includes the Internet, at least one WAN, at least one MAN, or any combination thereof. The term “WAN” is an abbreviation for “wide area network”. The term “MAN” is an abbreviation for “metropolitan area network”. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

The task management device 20 detects deterioration of the internal environment of the vehicle 30 as environmental deterioration during a period P1 in which the vehicle 30 is operated in a first mode M1. The task management device 20 calculates the time required for maintenance of the internal environment of the vehicle 30 in accordance with the detected environmental deterioration, and determines whether the maintenance is completed by a mode switching time limit Tm. The maintenance includes, for example, cleaning or deodorizing. The mode switching time limit Tm is a time line for switching the mode of the vehicle 30 to a second mode M2 that is different from the first mode M1. The task management device 20 executes operational control Ci in accordance with the obtained determination result. The operational control Ci is, for example, mode switching control C1 or vehicle introduction control C2. The mode switching control C1 is control for switching the vehicle 30 to the second mode M2. The vehicle introduction control C2 is control for introducing an alternative vehicle to be operated in the second mode M2.

The application corresponding to the first mode M1 may be any application. However, the application in the present embodiment is sale of products or delivery of articles. The application corresponding to the second mode M2 may be any application as long as the application is different from the application corresponding to the first mode M1. However, in the present embodiment, the application corresponding to the second mode M2 is transportation of passengers.

In the present embodiment, when the maintenance of the internal environment of the vehicle 30 cannot be performed by the time of switching the application of the vehicle 30, such as a change from a mobile store vehicle or a delivery vehicle to a bus, the operation can be changed. In other words, it is possible to perform a flexible operation in accordance with the time required for the maintenance of the internal environment of the vehicle 30.

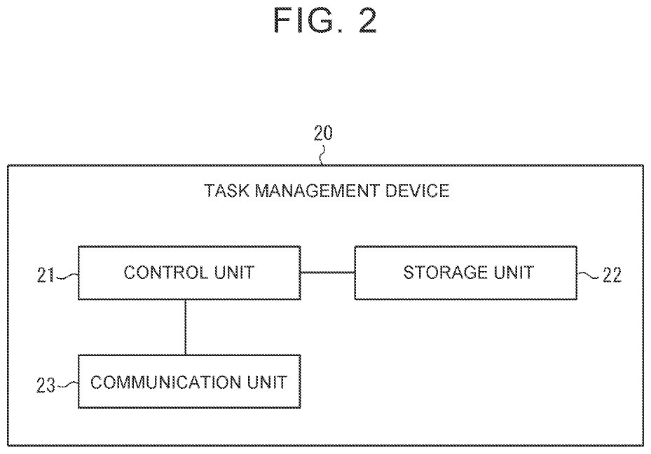

The configuration of the task management device 20 according to the present embodiment will be described with reference to FIG. 2.

The task management device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes processes related to the operation of the task management device 20 while controlling various units of the task management device 20.

The storage unit 22 includes at least one semiconductor memory, at least one magnetic memory, at least one optical memory, or any combination thereof. The semiconductor memory is, for example, a RAM, a ROM, or a flash memory. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The flash memory is, for example, an SSD. The term “SSD” is an abbreviation for solid-state drive. The magnetic memory is, for example, an HDD. The term “HDD” is an abbreviation for hard disk drive. The storage unit 22 functions as, for example, a main storage device, an auxiliary storage device, or a cache memory. The storage unit 22 stores data used for the operation of the task management device 20 and data acquired through the operation of the task management device 20.

The communication unit 23 includes at least one communication interface. The communication interface is, for example, an interface compatible with wired local area network (LAN) communication standards such as Ethernet (registered trademark), or an interface compatible with wireless LAN communication standards such as WEE802.11. The term “IEEE” is an abbreviation for Institute of Electrical and Electronics Engineers. The communication unit 23 communicates with the vehicle 30 and the terminal device 40. The communication unit 23 receives the data used for the operation of the task management device 20, and transmits the data acquired through the operation of the task management device 20.

The function of the task management device 20 is realized by executing the program according to the present embodiment with the processor serving as the control unit 21. That is, the function of the task management device 20 is realized by software. The program causes the computer to perform the operation of the task management device 20 such that the computer functions as the task management device 20. That is, the computer functions as the task management device 20 by performing the operation of the task management device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the task management device 20 may be realized by a programmable circuit or a dedicated circuit serving as the control unit 21. That is, a part or all of the functions of the task management device 20 may be realized by hardware.

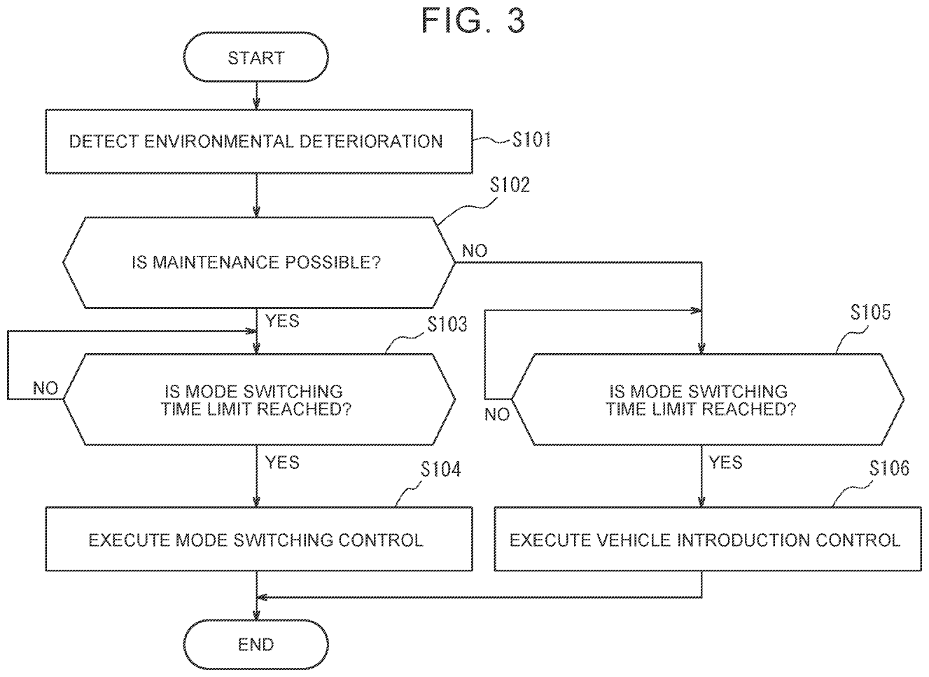

The operation of the task management device 20 according to the present embodiment will be described with reference to FIG. 3. This operation corresponds to a task management method according to the present embodiment.

In step S101, the control unit 21 of the task management device 20 detects deterioration of the internal environment of the vehicle 30 as the environmental deterioration during the period P1 in which the vehicle 30 is operated in the first mode M1. Specifically, the environmental deterioration is detected by either or both of the following procedures.

In a first procedure, the vehicle 30 captures an image of the inside of the vehicle 30 using a camera mounted on the vehicle 30 during the period P1. The vehicle 30 transmits the captured image to the task management device 20 via a communication interface that is mounted on the vehicle 30 and is compatible with mobile communication standards such as LTE, the 4G standard, or the 5G standard, V2X communication standards such as DSRC or cellular V2X, or wireless LAN communication standards such as IEEE 802.11. The term “LTE” is an abbreviation for “long term evolution”. The term “4G” is an abbreviation for “fourth generation”. The term “5G” is an abbreviation for “fifth generation”. The term “DSRC” is an abbreviation for “dedicated short range communications”. The term “V2X” is an abbreviation for “vehicle-to-everything”.

The control unit 21 of the task management device 20 receives the image of the inside of the vehicle 30 from the vehicle 30 via the communication unit 23. The control unit 21 detects dirt inside the vehicle 30 as the environmental deterioration by analyzing the received image. As a method of image analysis, a known method can be used. Machine learning such as deep learning may be used.

In a second procedure, the vehicle 30 measures the odor inside of the vehicle 30 using a sensor mounted on the vehicle 30 during the period P1. The vehicle 30 transmits the obtained measurement results to the task management device 20 via the communication interface mounted on vehicle 30.

The control unit 21 of the task management device 20 receives the measurement result of the odor of the vehicle 30 from the vehicle 30 via the communication unit 23. The control unit 21 detects dirt inside the vehicle 30 as the environmental deterioration with reference to the received measurement result.

In step S102, the control unit 21 of the task management device 20 calculates the time required for the maintenance of the internal environment of the vehicle in accordance with the environmental deterioration detected in step S101, and determines whether the maintenance is completed by the mode switching time limit Tm. The mode switching time limit Tm is a time line for switching the mode of the vehicle 30 to the second mode M2 that is different from the first mode M1. It is assumed that the mode switching time limit Tm is set in advance. Whether the maintenance is completed by the mode switching time limit Tm is specifically determined by the following procedure.

When the control unit 21 of the task management device 20 detects the dirt inside the vehicle 30 as the environmental deterioration in step S101, the control unit 21 calculates the time required for a cleaning staff member or a cleaning robot on board the vehicle 30 to clean the inside of the vehicle 30 as the time required for the maintenance. More specifically, the control unit 21 derives the cleaning time corresponding to parameters such as the amount or the type of dirt inside the vehicle 30 detected in step S101 as the time required for the maintenance with reference to a conversion table stored in the storage unit 22 in advance or using a predefined conversion formula.

When the odor inside the vehicle 30 is detected as the environmental deterioration in step S101, the control unit 21 of the task management device 20 calculates the time required for an air purifier mounted on the vehicle 30 to perform deodorizing inside the vehicle 30 as the time required for the maintenance. More specifically, the control unit 21 derives the operation time of the air purifier corresponding to parameters such as the intensity or the type of odor inside the vehicle 30 detected in step S101 as the time required for the maintenance with reference to a conversion table stored in the storage unit 22 in advance or using a predefined conversion formula.

The control unit 21 of the task management device 20 compares the calculated time required for the maintenance time with the remaining time until the mode switching time limit Tm. When the time required for the maintenance is shorter than the remaining time, the control unit 21 determines that the maintenance is completed by the mode switching time limit Tm. When the time required for the maintenance is the same as the remaining time, the control unit 21 may also determine that the maintenance is completed by the mode switching time limit Tm. When the time required for the maintenance is longer than the remaining time, the control unit 21 determines that the maintenance is not completed by the mode switching time limit Tm.

When the control unit 21 determines in step S102 that the maintenance is completed by the mode switching time limit Tm, the process in step S103 is executed. When the control unit 21 determines in step S102 that the maintenance is not completed by the mode switching time limit Tm, the process in step S105 is executed.

In step S103, the control unit 21 of the task management device 20 waits until the mode switching time limit Tm is reached or the use of the vehicle 30 in the first mode M1 is completed. When the mode switching time limit Tm is reached, the process in step S104 is executed. When the use of the vehicle 30 in the first mode M1 is completed even before the mode switching time limit Tm, the process in step S104 is executed.

In step S104, the control unit 21 of the task management device 20 executes the mode switching control C1 as the operational control Ci in accordance with the determination result obtained in step S102. The mode switching control C1 is control for switching the mode of the vehicle 30 to the second mode M2.

Specifically, the control unit 21 of the task management device 20 transmits first instruction data Di1 for instructing the operator to change the interior or the exterior of the vehicle 30 to the interior or the exterior corresponding to the second mode M2 to the terminal device of the operator, such as a mobile phone, a smart phone, or a tablet, via the communication unit 23, thereby executing the mode switching control C1. Upon receipt of the first instruction data Di1, the terminal device of the operator displays the received first instruction data Di1 on the display or outputs the received first instruction data Di1 by voice from the speaker. The operator changes the interior or the exterior of the vehicle 30 in accordance with the first instruction data Di1 displayed or output by voice. For example, the operator installs rear seats for bus passengers to be seated or moves rear seats to specific positions. Alternatively, the operator may cause a display provided as part of the exterior of the vehicle 30 to display operation information such as the destination of the bus.

When the vehicle 30 has a function of automatically changing the interior or the exterior of the vehicle 30, the control unit 21 of the task management device 20 may execute the mode switching control C1 by transmitting a second instruction data Di2 for instructing the vehicle 30 to change the interior or the exterior of the vehicle 30 to the interior or the exterior corresponding to the second mode M2 to the vehicle 30 via the communication unit 23, instead of or in addition to transmission of the first instruction data Di1 to the terminal device of the operator. In such a modification, the vehicle 30 receives the second instruction data Di2 from the task management device 20 via the communication interface mounted on vehicle 30. The vehicle 30 changes the interior or the exterior of the vehicle 30 in accordance with the received second instruction data Di2. For example, the vehicle 30 moves rear seats for the bus passengers to be seated to the specific positions. Alternatively, the vehicle 30 may display the operation information such as the destination of the bus on a display provided as part of the exterior of the vehicle 30.

In step S105, the control unit 21 of the task management device 20 waits until the mode switching time limit Tm is reached or the use of the vehicle 30 in the first mode M1 is completed. When the mode switching time limit Tm is reached, the process in step S106 is executed. When the use of the vehicle 30 in the first mode M1 is completed even before the mode switching time limit Tm, the process in step S106 is executed.

In step S106, the control unit 21 of the task management device 20 executes the vehicle introduction control C2 as the operational control Ci in accordance with the determination result obtained in step S102. The vehicle introduction control C2 is control for introducing an alternative vehicle operated in the second mode M2.

Specifically, the control unit 21 of the task management device 20 executes the vehicle introduction control C2 by transmitting third instruction data Di3 that instructs the alternative vehicle to transport the passengers that are supposed to be transported during a period P2 during which the vehicle 30 is scheduled to be operated in the second mode M2 after the period P1 to the alternative vehicle via the communication unit 23. When the mode of the alternative vehicle is switched by changing the interior, the exterior, or both in the same manner as the vehicle 30, the third instruction data Di3 may include data that instructs a change of the interior or the exterior of the alternative vehicle to the interior or the exterior corresponding to the second mode M2. Upon receipt of the third instruction data Di3, the alternative vehicle transports the passengers in accordance with the received third instruction data Di3.

As described above, in the present embodiment, when the vehicle 30 is operated for distribution purposes, the time required for detecting the environmental deterioration such as dirt inside the vehicle 30 and improving the environment such as removal of the dirt inside the vehicle 30 is calculated, whereby another vehicle can be dispatched as a bus when the required time is long. In other words, it is possible to perform a flexible operation in accordance with the time required to improve the internal environment of the vehicle 30.

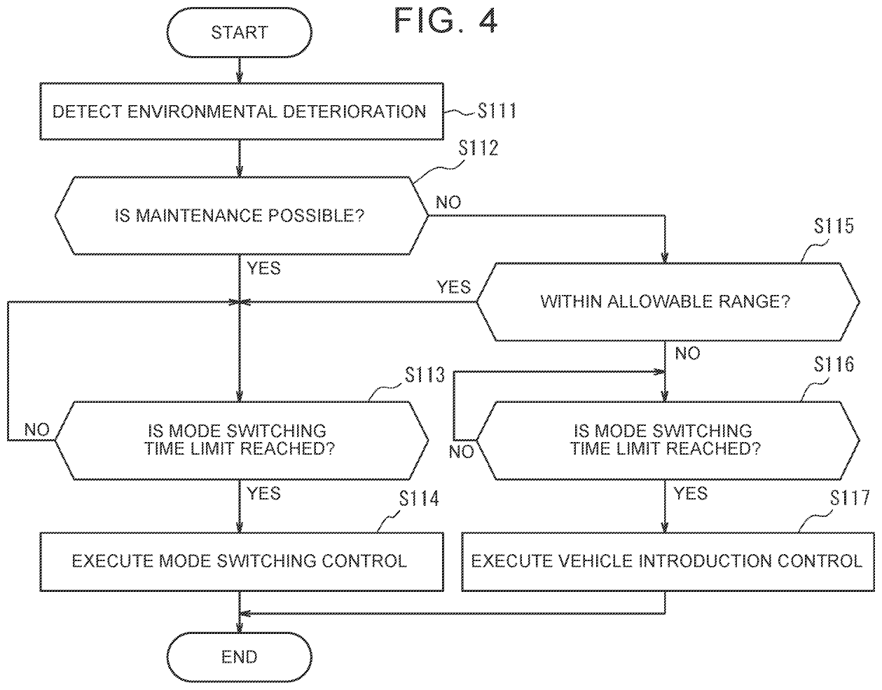

A modification of the operation of the task management device 20 according to the present embodiment will be described with reference to FIG. 4.

The processes in steps S111 and S112 are the same as the processes in steps S101 and S102 in FIG. 3, respectively, and thus description thereof will be omitted.

When the control unit 21 determines in step S112 that the maintenance is completed by the mode switching time limit Tm, the process in step S113 is executed. When the control unit 21 determines in step S112 that the maintenance is not completed by the mode switching time limit Tm, the process in step S115 is executed.

The processes in steps S113 and S114 are the same as the processes in steps S103 and S104 in FIG. 3, respectively, and thus description thereof will be omitted.

In step S115, the control unit 21 of the task management device 20 determines whether to execute the vehicle introduction control C2 in accordance with the environmental deterioration detected in step S111. Whether to execute the vehicle introduction control C2 is specifically determined by the following procedure.

The control unit 21 of the task management device 20 determines whether the environmental deterioration detected in step S111 is acceptable with reference to tolerance data Da that is stored in the storage unit 22 in advance. The tolerance data Da is data indicating tolerance for deterioration of the internal environment of the vehicle 30 for the application in the second mode M2. Such data can be, for example, a correspondence table that defines corresponding tolerance for each application such as delivery of articles, transportation of passengers, or sale of products. In this correspondence table, the tolerance corresponding to delivery of articles may be defined higher than the tolerance corresponding to sale of products. The tolerance corresponding to the sale of products may be defined higher than the tolerance corresponding to the transportation of passengers. The applications may be subdivided, with corresponding tolerances defined for each subdivision. The tolerance is expressed, for example, by the amount of dirt that is allowable or the intensity of odor that is allowable.

The tolerance data Da may be data indicating the tolerance for deterioration of the internal environment of the vehicle 30 for targets to be transported in the second mode M2. For such data, for example, the correspondence table that defines tolerances corresponding to articles such as luggage delivered by the vehicle 30, products such as bread sold by the vehicle 30, or passengers transported by the vehicle 30 can be used. In this correspondence table, the tolerance corresponding to the articles delivered by the vehicle 30 may be defined higher than the tolerance corresponding to the products sold by the vehicle 30. The tolerance corresponding to the products sold by the vehicle 30 may be defined higher than the tolerance corresponding to the passengers transported by the vehicle 30. The target objects may be subdivided, with corresponding tolerances defined for each subdivision.

When the control unit 21 of the task management device 20 determines that the environmental deterioration detected in step S111 is allowable, the control unit 21 determines not to execute the vehicle introduction control C2. When the control unit 21 determines that the environmental deterioration detected in step S111 is not allowable, the control unit 21 determines to execute the vehicle introduction control C2.

When a determination is made in step S115 that the vehicle introduction control C2 is not executed, the process in step S113 is executed. When a determination is made in step S115 that the vehicle introduction control C2 is executed, the process in step S116 is executed.

The processes in steps S116 and S117 are the same as the processes in steps S105 and S106 in FIG. 3, respectively, and thus description thereof will be omitted.

As described above, in the example shown in FIG. 4, even when it takes time to improve the environment such as removal of the dirt inside the vehicle 30, the vehicle 30 is utilized as a bus as long as the environmental deterioration such as the dirt inside the vehicle 30 is within the allowable range. Therefore, there is no need to dispatch another vehicle as a bus. In other words, it is possible to perform a flexible operation in accordance with the environmental deterioration inside the vehicle 30. For example, the states of the internal environments of a plurality of vehicles including the vehicle 30 may be ranked and matched with the applications applied for by a plurality of users including the user 11. When the user 11 has applied for the use of the vehicle 30 as a bus, the user 11 may be allowed to reserve the highest ranked vehicle.

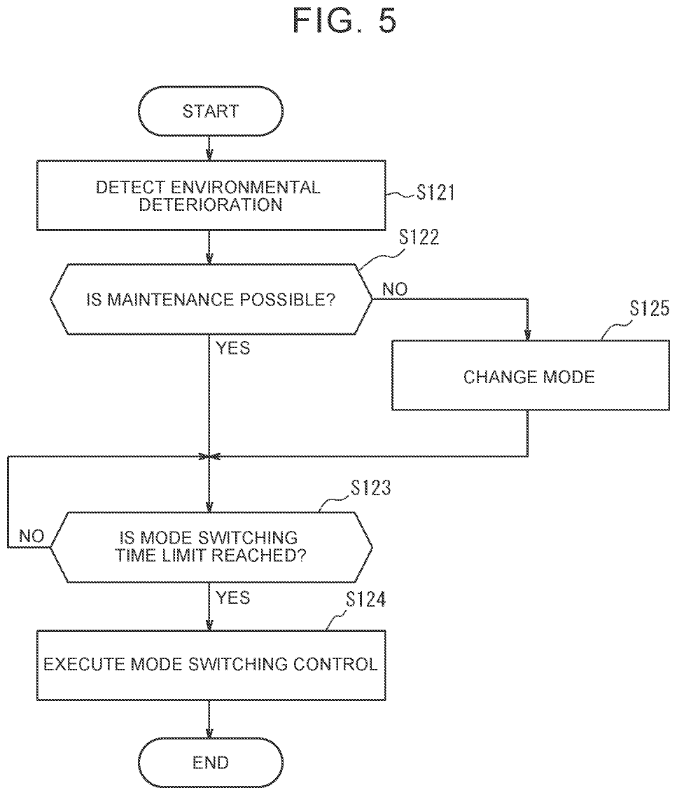

Another modification of the operation of the task management device 20 according to the present embodiment will be described with reference to FIG. 5.

The processes in steps S121 and S122 are the same as the processes in steps S101 and S102 in FIG. 3, respectively, and thus description thereof will be omitted.

When the control unit 21 determines in step S122 that the maintenance is completed by the mode switching time limit Tm, the process in step S123 is executed. When the control unit 21 determines in step S122 that the maintenance is not completed by the mode switching time limit Tm, the process in step S125 is executed.

The processes in steps S123 and S124 are the same as the processes in steps S103 and S104 in FIG. 3, respectively, and thus description thereof will be omitted.

In step S125, the control unit 21 of the task management device 20 changes the switching destination mode of the mode switching control C1 from the second mode M2 to the third mode M3 corresponding to the application in accordance with the environmental deterioration detected in step S121. Specifically, the switching destination mode is changed in the following procedure.

The control unit 21 of the task management device 20 determines in which mode the environmental deterioration detected in step S121 is acceptable with reference to the tolerance data Da that is stored in the storage unit 22 in advance. Since the tolerance data Da is the same as that referred to in step S115 of FIG. 4, the description thereof will be omitted.

When the control unit 21 of the task management device 20 determines that the environmental deterioration detected in step S121 is allowable in the mode corresponding to the delivery of the articles, the control unit 21 selects the mode corresponding to the delivery of the articles as the third mode M3. When the control unit 21 determines that the environmental deterioration detected in step S121 is allowable in the mode corresponding to the sale of the products, the control unit 21 selects the mode corresponding to the sale of the products as the third mode M3. When the control unit 21 determines that the environmental deterioration detected in step S121 is allowable in two or more modes, the control unit 21 may select an arbitrary mode from among the two or more modes as the third mode M3, or may select any one of the modes as the third mode M3 in accordance with a certain priority. The control unit 21 changes the switching destination mode of the mode switching control C1 to the selected third mode M3. When the control unit 21 determines that the environmental deterioration detected in step S121 is allowable in the second mode M2, it is not necessary to change the switching destination mode of the mode switching control C1.

After step S125, the processes in steps S123 and S124 are executed. When the switching destination mode of the mode switching control C1 is changed to the third mode M3 in step S125, in step S124, the control unit 21 of the task management device 20 executes the mode switching control C1 to switch the vehicle 30 to the third mode M3, instead of the second mode M2.

Specifically, the control unit 21 of the task management device 20 executes the mode switching control C1 by transmitting the fourth instruction data Di4 for instructing the operator to change the interior or the exterior of the vehicle 30 to the interior or the exterior corresponding to the third mode M3 to the terminal device of the operator via the communication unit 23. Upon receipt of the fourth instruction data Di4, the terminal device of the operator displays the received fourth instruction data Di4 on the display or outputs the received fourth instruction data Di4 by voice from the speaker. The operator changes the interior or the exterior of the vehicle 30 in accordance with the fourth instruction data Di4 displayed or output by voice.

When the vehicle 30 has a function of automatically changing the interior or the exterior of the vehicle 30, the control unit 21 of the task management device 20 may execute the mode switching control C1 by transmitting a fifth instruction data Di5 for instructing the vehicle 30 to change the interior or the exterior of the vehicle 30 to the interior or the exterior corresponding to the third mode M3 to the vehicle 30 via the communication unit 23, instead of or in addition to transmission of the fourth instruction data Di4 to the terminal device of the operator. In such a modification, the vehicle 30 receives the fifth instruction data Di5 from the task management device 20 via the communication interface mounted on vehicle 30. The vehicle 30 changes the interior or the exterior of the vehicle 30 in accordance with the received fifth instruction data Di5.

As described above, in the example shown in FIG. 5, even when it takes time to improve the environment such as removal of the dirt inside the vehicle 30, the vehicle is utilized for another purpose that allows the environmental deterioration such as the dirt inside the vehicle 30. In other words, it is possible to perform a flexible operation in accordance with the environmental deterioration inside the vehicle 30. For example, in distribution, the inside of the vehicle 30 only needs to be kept clean to the minimum necessary extent. Therefore, when the time required for cleaning inside the vehicle 30 cannot be taken, the next operation of the vehicle 30 only needs to be changed from the purpose of passenger transportation to the purpose of distribution.

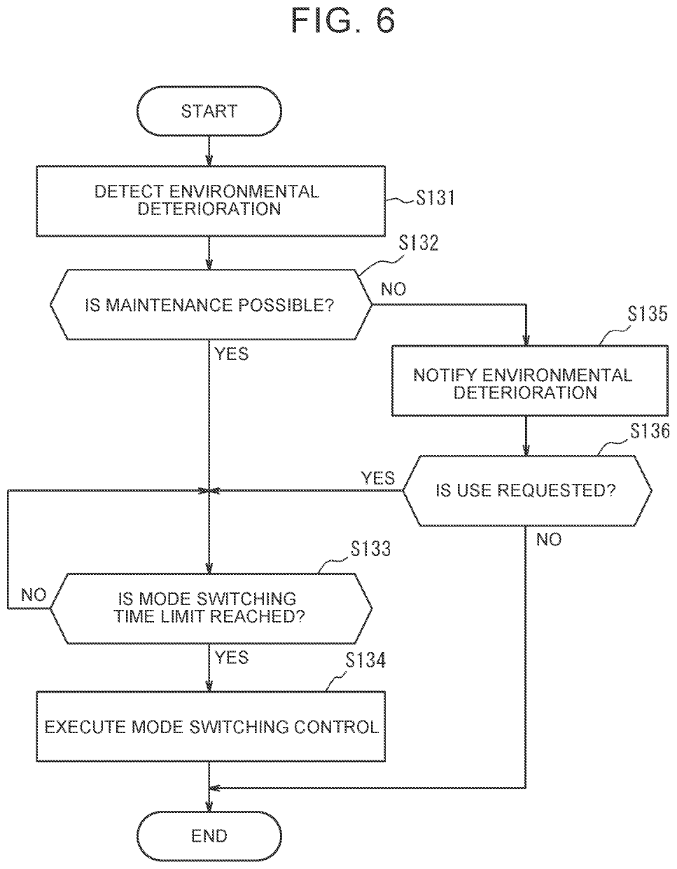

Still another modification of the operation of the task management device 20 according to the present embodiment will be described with reference to FIG. 6.

The processes in steps S131 and S132 are the same as the processes in steps S101 and S102 in FIG. 3, respectively, and thus description thereof will be omitted.

When the control unit 21 determines in step S132 that the maintenance is completed by the mode switching time limit Tm, the process in step S133 is executed. When the control unit 21 determines in step S132 that the maintenance is not completed by the mode switching time limit Tm, the process in step S135 is executed.

The processes in steps S133 and S134 are the same as the processes in steps S103 and S104 in FIG. 3, respectively, and thus description thereof will be omitted.

In step S135, the control unit 21 of the task management device 20 transmits notification data Dn for notifying the user 11 of the environmental deterioration detected in step S131 to the terminal device 40 via the communication unit 23. The notification data Dn is specifically transmitted in the following procedure.

When the control unit 21 of the task management device 20 detects dirt inside the vehicle 30 as the environmental deterioration in step S131, the control unit 21 transmits data that notifies the user 11 of information such as the amount or type of detected dirt inside the vehicle 30 to the terminal device 40 via the communication unit 23 as the notification data Dn. The notification data Dn may contain a message “For customers who have booked a bus: Please understand that the inside of the bus may have some dirt because the inside of the bus will not be cleaned in time, and if you wish to use the bus, please let us know.”, and a message “You can get a discount on bus usage fee.”, for example.

When the control unit 21 of the task management device 20 detects the odor inside the vehicle 30 as the environmental deterioration in step S131, the control unit 21 transmits data that notifies the user 11 of information such as the intensity or type of detected odor inside the vehicle 30 to the terminal device 40 via the communication unit 23 as the notification data Dn.

The terminal device 40 of the task management device 20 receives the notification data Dn from the task management device 20 via a communication interface that is mounted on the terminal device 40 and is compatible with mobile communication standards such as LTE, the 4G standard, or the 5G standard, wireless LAN communication standards such as IEEE 802.11, or wired LAN communication standards such as Ethernet (registered trademark). The terminal device 40 displays the received notification data Dn on a display mounted on or connected to the terminal device 40, or outputs the received notification data Dn by voice from a speaker mounted on or connected to the terminal device 40. When the user 11 can tolerate the environmental deterioration such as dirt or odor notified by the notification data Dn displayed or output by voice, the user 11 may perform an operation to request the use of the vehicle 30 when the vehicle 30 is operated in the second mode M2. When such an operation is performed, the terminal device 40 transmits request data Dr requesting the use of the vehicle 30 when the vehicle 30 is operated in the second mode M2 to the task management device 20 via the communication interface installed in the terminal device 40.

In step S136, the control unit 21 of the task management device 20 waits until the request data Dr is received from the terminal device 40 via the communication unit 23. When the request data Dr is received, the process in step S133 is executed. In step S135, when the request data Dr is not received even after a certain period of time has passed from the transmission of the notification data Dn, the operation shown in FIG. 6 ends. When the user 11 has made a reservation to use the vehicle 30 when the vehicle 30 is operated in the second mode M2, the reservation may be automatically canceled. Alternatively, the processes in steps S116 and S117 of FIG. 4 may be executed.

As described above, in the example shown in FIG. 6, when it takes time to improve the environment such as removal of the dirt inside the vehicle 30, the user 11 is notified of the environmental deterioration such as the dirt inside the vehicle 30, and the vehicle 30 can be operated as a bus after a confirmation is made that the user 11 still wishes to use the vehicle 30. In other words, it is possible to perform a flexible operation in accordance with the environmental deterioration inside the vehicle 30. For example, the state of the internal environment of the vehicle 30 may be made public, and the user who wishes to use the vehicle 30 as a bus may be recruited from among a plurality of users including the user 11.

As a modification of the present embodiment, the task management device 20 may be provided in the vehicle 30.

A part of the embodiment of the present disclosure is shown as an example below. However, it should be noted that embodiment of the present disclosure is not limited to these.

### APPENDIX 1

A task management device includes a control unit that detects a deterioration of an internal environment of a vehicle as an environmental deterioration during a period in which the vehicle to be operated in a mode in accordance with an application is operated in a first mode, calculates a time required for maintenance of the internal environment of the vehicle in accordance with the detected environmental deterioration and determines whether the maintenance is completed by a mode switching time limit for switching the mode of the vehicle to a second mode that is different from the first mode, and executes operational control in accordance with a determination result obtained.

### APPENDIX 2

In the task management device according to Appendix 1, when the control unit determines that the maintenance is not completed by the mode switching time limit, the control unit executes vehicle introduction control for introducing an alternative vehicle that is operated in the second mode by the mode switching time limit.

### APPENDIX 3

In the task management device according to Appendix 1, when the control unit determines that the maintenance is not completed by the mode switching time limit, the control unit determines whether to execute vehicle introduction control for introducing an alternative vehicle that is operated in the second mode in accordance with the environmental deterioration.

### APPENDIX 4

In the task management device according to Appendix 3, when the control unit determines that the maintenance is not completed by the mode switching time limit, the control unit determines whether the environmental deterioration is allowable with reference to tolerance data indicating tolerance with respect to the deterioration of the internal environment of the vehicle for an application corresponding to the second mode, executes mode switching control for switching the mode of the vehicle to the second mode by the mode switching time limit when the control unit determines that the environmental deterioration is allowable, and executes the vehicle introduction control by the mode switching time limit when the control unit determines that the environmental deterioration is not allowable.

### APPENDIX 5

In the task management device according to Appendix 3, when the control unit determines that the maintenance is not completed by the mode switching time limit, the control unit determines whether the environmental deterioration is allowable with reference to tolerance data indicating tolerance with respect to the deterioration of the internal environment of the vehicle for a target to be transported in the second mode, executes mode switching control for switching the mode of the vehicle to the second mode by the mode switching time limit when the control unit determines that the environmental deterioration is allowable, and executes the vehicle introduction control by the mode switching time limit when the control unit determines that the environmental deterioration is not allowable.

### APPENDIX 6

In the task management device according to Appendix 1, when the control unit determines that the maintenance is not completed by the mode switching time limit, the control unit executes mode switching control for switching the mode of the vehicle to a third mode corresponding to an application in accordance with the environmental deterioration, instead of the second mode, by the mode switching time limit.

### APPENDIX 7

The task management device according to Appendix 1 further includes a communication unit that performs communication with a terminal device of a user, and when the control unit determines that the maintenance is not completed by the mode switching time limit, the control unit transmits notification data that notifies the user of the environmental deterioration to the terminal device via the communication unit, and when request data that requests use of the vehicle with the vehicle operated in the second mode is received from the terminal device via the communication unit, the control unit executes mode switching control for switching the mode of the vehicle to the second mode by the mode switching time limit.

### APPENDIX 8

In the task management device according to any one of Appendices 1 to 7, an application corresponding to the first mode is sale of a product or delivery of an article, and an application corresponding to the second mode is transportation of a passenger.

### APPENDIX 9

In the task management device according to any one of Appendices 1 to 8, the maintenance includes cleaning.

### APPENDIX 10

In the task management device according to any one of Appendices 1 to 9, the maintenance includes deodorizing.

### APPENDIX 11

A system includes: the task management device according to Appendix 7; and the terminal device.

### APPENDIX 12

A vehicle includes the task management device according to any one of Appendices 1 to 10.

### APPENDIX 13

A task management method includes: detecting, by a control unit, deterioration of an internal environment of a vehicle as an environmental deterioration during a period in which the vehicle to be operated in a mode in accordance with an application is operated in a first mode; by the control unit, calculating a time required for maintenance of the internal environment of the vehicle in accordance with the detected environmental deterioration and determining whether the maintenance is completed by a mode switching time limit for switching the mode of the vehicle to a second mode that is different from the first mode; and executing, by the control unit, operational control in accordance with a determination result obtained.

### APPENDIX 14

In the task management method according to Appendix 13, the executing includes, when the maintenance is determined to be not completed by the mode switching time limit, executing vehicle introduction control for introducing an alternative vehicle that is operated in the second mode by the mode switching time limit.

### APPENDIX 15

In the task management method according to Appendix 13, the executing includes, when the maintenance is determined to be not completed by the mode switching time limit, determining whether to execute vehicle introduction control for introducing an alternative vehicle that is operated in the second mode in accordance with the environmental deterioration.

### APPENDIX 16

In the task management method according to Appendix 15, the executing includes: determining, when the maintenance is determined to be not completed by the mode switching time limit, whether the environmental deterioration is allowable with reference to tolerance data indicating tolerance with respect to the deterioration of the internal environment of the vehicle for an application corresponding to the second mode; executing mode switching control for switching the mode of the vehicle to the second mode by the mode switching time limit when the environmental deterioration is determined to be allowable; and executing the vehicle introduction control by the mode switching time limit when the environmental deterioration is determined to be not allowable.

### APPENDIX 17

In the task management method according to Appendix 15, the executing includes: determining, when the maintenance is determined to be not completed by the mode switching time limit, whether the environmental deterioration is allowable with reference to tolerance data indicating tolerance with respect to the deterioration of the internal environment of the vehicle for a target to be transported in the second mode; executing mode switching control for switching the mode of the vehicle to the second mode by the mode switching time limit when the environmental deterioration is determined to be allowable; and executing the vehicle introduction control by the mode switching time limit when the environmental deterioration is determined to be not allowable.

### APPENDIX 18

In the task management method according to Appendix 13, the executing includes, when the maintenance is determined to be not completed by the mode switching time limit, executing mode switching control for switching the mode of the vehicle to a third mode corresponding to an application in accordance with the environmental deterioration, instead of the second mode, by the mode switching time limit.

### APPENDIX 19

In the task management method according to Appendix 13, the executing includes: transmitting, when the maintenance is determined to be not completed by the mode switching time limit, notification data that notifies a user of the environmental deterioration to a terminal device of the user; and executing, when request data that requests use of the vehicle with the vehicle operated in the second mode is received from the terminal device, mode switching control for switching the mode of the vehicle to the second mode by the mode switching time limit.

### APPENDIX 20

In the task management method according to any one of Appendices 13 to 19, an application corresponding to the first mode is sale of a product or delivery of an article, and an application corresponding to the second mode is transportation of a passenger.

The present disclosure is not limited to the embodiments described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A task management device comprising a control unit that detects a deterioration of an internal environment of a vehicle as an environmental deterioration during a period in which the vehicle to be operated in a mode in accordance with an application is operated in a first mode, calculates a time required for maintenance of the internal environment of the vehicle in accordance with the detected environmental deterioration and determines whether the maintenance is completed by a mode switching time limit for switching the mode of the vehicle to a second mode that is different from the first mode, and executes operational control in accordance with a determination result obtained.

2. The task management device according to claim 1, wherein when the control unit determines that the maintenance is not completed by the mode switching time limit, the control unit executes vehicle introduction control for introducing an alternative vehicle that is operated in the second mode by the mode switching time limit.

3. The task management device according to claim 1, wherein when the control unit determines that the maintenance is not completed by the mode switching time limit, the control unit determines whether to execute vehicle introduction control for introducing an alternative vehicle that is operated in the second mode in accordance with the environmental deterioration.

4. The task management device according to claim 3, wherein when the control unit determines that the maintenance is not completed by the mode switching time limit, the control unit determines whether the environmental deterioration is allowable with reference to tolerance data indicating tolerance with respect to the deterioration of the internal environment of the vehicle for an application corresponding to the second mode, executes mode switching control for switching the mode of the vehicle to the second mode by the mode switching time limit when the control unit determines that the environmental deterioration is allowable, and executes the vehicle introduction control by the mode switching time limit when the control unit determines that the environmental deterioration is not allowable.

5. The task management device according to claim 3, wherein when the control unit determines that the maintenance is not completed by the mode switching time limit, the control unit determines whether the environmental deterioration is allowable with reference to tolerance data indicating tolerance with respect to the deterioration of the internal environment of the vehicle for a target to be transported in the second mode, executes mode switching control for switching the mode of the vehicle to the second mode by the mode switching time limit when the control unit determines that the environmental deterioration is allowable, and executes the vehicle introduction control by the mode switching time limit when the control unit determines that the environmental deterioration is not allowable.

6. The task management device according to claim 1, wherein when the control unit determines that the maintenance is not completed by the mode switching time limit, the control unit executes mode switching control for switching the mode of the vehicle to a third mode corresponding to an application in accordance with the environmental deterioration, instead of the second mode, by the mode switching time limit.

7. The task management device according to claim 1, further comprising a communication unit that performs communication with a terminal device of a user, wherein when the control unit determines that the maintenance is not completed by the mode switching time limit, the control unit transmits notification data that notifies the user of the environmental deterioration to the terminal device via the communication unit, and when request data that requests use of the vehicle with the vehicle operated in the second mode is received from the terminal device via the communication unit, the control unit executes mode switching control for switching the mode of the vehicle to the second mode by the mode switching time limit.

8. The task management device according to claim 1, wherein an application corresponding to the first mode is sale of a product or delivery of an article, and an application corresponding to the second mode is transportation of a passenger.

9. The task management device according to claim 1, wherein the maintenance includes cleaning.

10. The task management device according to claim 1, wherein the maintenance includes deodorizing.

11. A system comprising:
the task management device according to claim 7; and
the terminal device.

12. A vehicle comprising the task management device according to claim 1.

13. A task management method comprising:
detecting, by a control unit, deterioration of an internal environment of a vehicle as an environmental deterioration during a period in which the vehicle to be operated in a mode in accordance with an application is operated in a first mode;
by the control unit, calculating a time required for maintenance of the internal environment of the vehicle in accordance with the detected environmental deterioration and determining whether the maintenance is completed by a mode switching time limit for switching the mode of the vehicle to a second mode that is different from the first mode; and
executing, by the control unit, operational control in accordance with a determination result obtained.

14. The task management method according to claim 13, wherein the executing includes, when the maintenance is determined to be not completed by the mode switching time limit, executing vehicle introduction control for introducing an alternative vehicle that is operated in the second mode by the mode switching time limit.

15. The task management method according to claim 13, wherein the executing includes, when the maintenance is determined to be not completed by the mode switching time limit, determining whether to execute vehicle introduction control for introducing an alternative vehicle that is operated in the second mode in accordance with the environmental deterioration.

16. The task management method according to claim 15, wherein the executing includes:
determining, when the maintenance is determined to be not completed by the mode switching time limit, whether the environmental deterioration is allowable with reference to tolerance data indicating tolerance with respect to the deterioration of the internal environment of the vehicle for an application corresponding to the second mode;
executing mode switching control for switching the mode of the vehicle to the second mode by the mode switching time limit when the environmental deterioration is determined to be allowable; and
executing the vehicle introduction control by the mode switching time limit when the environmental deterioration is determined to be not allowable.

17. The task management method according to claim 15, wherein the executing includes:
determining, when the maintenance is determined to be not completed by the mode switching time limit, whether the environmental deterioration is allowable with reference to tolerance data indicating tolerance with respect to the deterioration of the internal environment of the vehicle for a target to be transported in the second mode;
executing mode switching control for switching the mode of the vehicle to the second mode by the mode switching time limit when the environmental deterioration is determined to be allowable; and
executing the vehicle introduction control by the mode switching time limit when the environmental deterioration is determined to be not allowable.

18. The task management method according to claim 13, wherein the executing includes, when the maintenance is determined to be not completed by the mode switching time limit, executing mode switching control for switching the mode of the vehicle to a third mode corresponding to an application in accordance with the environmental deterioration, instead of the second mode, by the mode switching time limit.

19. The task management method according to claim 13, wherein the executing includes:
transmitting, when the maintenance is determined to be not completed by the mode switching time limit, notification data that notifies a user of the environmental deterioration to a terminal device of the user; and
executing, when request data that requests use of the vehicle with the vehicle operated in the second mode is received from the terminal device, mode switching control for switching the mode of the vehicle to the second mode by the mode switching time limit.

20. The task management method according to claim 13, wherein an application corresponding to the first mode is sale of a product or delivery of an article, and an application corresponding to the second mode is transportation of a passenger.
